(19) United States
(12) Patent Application Publication
(10) Pub. No.: US 2012/0203936 A1
(43) Pub. Date: Aug. 9, 2012

(54) DIRECT PERIPHERAL INTERCONNECT

(75) Inventor: Erik Fossum Faerevaag, Bergen (NO)

(73) Assignee: Energy Micro AS, Oslo (NO)

(21) Appl. No.: 13/501,510

(22) PCT Filed: Oct. 14, 2010
(86) PCT No.: PCT/IB10/02875

§ 371 Date: Apr. 12, 2012

Related U.S. Application Data
(60) Provisional application No. 61/254,607, filed on Oct. 23, 2009.

(51) Int. Cl. G06F 3/00

(52) U.S. Cl. 710/11

(57) ABSTRACT

A direct peripheral interconnect (DPI) device and a method for providing a direct interconnect between peripherals are disclosed. The DPI device includes a selector configured to receive producer signals output by peripherals and control signals output by a control unit. The selector is configured to select and output one or more producer signals as an operable signal based on the received control signals. The DPI device also includes an operator having functions stored therein. The operator is configured to receive the operable signal and the control signals, and perform one or more of the functions on the operable signal based on the received control signals. The operator is configured to output a consumer signal corresponding to the operable signal, as well as a status signal providing update information to the main control unit.

### CROSS-REFERENCE TO RELATED APPLICATION

This application claims priority to U.S. Provisional Application Ser. No. 61/251,607, filed on Oct. 14, 2009.

### BACKGROUND

1. Technical Field

The present disclosure relates to peripheral networks, and more particularly, to a system and method for providing direct communications between peripherals so as to minimize dependencies upon a main control unit.

2. Description of the Related Art

Peripherals are well known and commonly used in the electrical arts as devices that are operated by a main control unit, such as a controller, processor, or the like, and dedicated to perform tasks from within a computer, electronic device, or the like. Moreover, peripherals are instructed to support a main control unit by operating as a timer, analog to digital converter (ADC), digital to analog converter (DAC), direct memory access (DMA), counter, comparator, or the like.

As commonly applied today, peripherals are typically controlled directly by a main or central processing unit (CPU) by way of a general or a dedicated bus system. For each set of peripheral tasks that must be performed, the CPU must configure the peripherals, wait for the peripherals to complete the tasks, determine the result provided by the associated peripherals, and proceed onto the next set of peripheral tasks which must be performed. Accordingly, the CPU is involved in all aspects of the peripheral operations, which also indicates that the CPU is being initialized or at least powered on during these tasks. Furthermore, if the CPU is on, the voltage regulator, power supply, clock tree, and the like, are also powered on, which accounts for a substantial amount of power consumed overall. Additionally, as the CPU must configure peripherals and wait for the peripherals to perform a particular task, the timing of operations is unpredictable. Moreover, the unpredictable timing of such systems creates difficulties in scheduling and/or planning tasks or activities for other components unrelated to the peripherals.

Therefore, there is a need for an improved peripheral network structure that can significantly reduce power consumption and limit the effects of latency. Moreover, there is a need for a peripheral network structure capable of performing tasks autonomously with substantially less intervention from a central control unit. There is also a need for a peripheral network structure which provides a main control unit with more predictable timing characteristics. Specifically, there is a need for a system and a method which provide direct communications between peripherals so as to signal and trigger peripheral tasks with minimal input from a central control unit.

### SUMMARY OF THE DISCLOSURE

In satisfaction of the aforenoted needs, a direct peripheral interconnect (DPI) device and a method for providing direct interconnections between one or more peripherals so as to minimize interactions with a main control unit are disclosed.

An interconnect apparatus for providing direct interconnections between one or more peripherals so as to minimize interactions with a main control unit is provided. The interconnect apparatus includes a selector configured to receive producer signals output by peripherals and control signals output by a control unit. The selector is configured to select and output one or more producer signals as an operable signal based on the received control signals. The interconnect apparatus also includes an operator having functions stored therein. The operator is configured to receive the operable signal and the control signals, and perform one or more of the functions on the operable signal based on the received control signals. The operator is configured to output a consumer signal corresponding to the operable signal, as well as a status signal providing update information to the main control unit.

In a refinement, the interconnect apparatus additionally includes an interface communicatively disposed between the main control unit and each of the selector and operator.

In another refinement, the main control unit is a central processing unit.

In another refinement, the selector is a multiplexer.

In another refinement, the control signals include information pertaining to the producer signals to be selected as the operable signal.

In another refinement, the control signals include information pertaining to the function to be performed on the operable signal.

In another refinement, the status signal includes information pertaining to the at least one function performed.

In another refinement, the functions are generalized so as to be executable on pulsed or level operable signals.

In another refinement, before performing any function, the operator is configured to determine if one of the functions must be performed, based on at least one of the operable and control signals received.

In another refinement, the interconnect apparatus additionally includes a second selector configured to receive the control signals, select at least one of the peripherals as destination peripherals, and output the consumer signal to only the destination peripherals.

In another refinement, each of the selector and operator has predictable timing characteristics.

In another refinement, each of the selector and operator is autonomous.

In yet another refinement, each of the selector and operator includes substantially low latency and low jitter operations.

A method for providing an autonomous direct interconnect between one or more peripherals so as to minimize interactions with a main control unit is disclosed. Moreover, the method includes the steps of receiving producer signals output by the peripherals at the interconnect, receiving control signals output by the main control unit at the interconnect, selecting at least one of the producer signals as an operable signal based on the control signals, selecting one or more functions to perform on the operable signal based on the control signals, performing at least one of the functions on the operable signal, outputting a consumer signal corresponding to the operable signal and the function performed to at least one of the peripherals, and outputting a status signal accessible for the main control unit.

In a refinement, the functions are generalized so as to be executable on pulsed or level operable signals.

In another refinement, the functions are configurable through an interface.

In another refinement, each producer signal is synchronized with a clock of the associated peripheral.

In another refinement, the step of selecting at least one of the functions is performed by at least one multiplexer.

In another refinement, the status signal includes information pertaining to the consumer signal and the function performed.

In yet another refinement, the timing of each of step is predictable.

Other advantages and features will be apparent from the following detailed description when read in conjunction with the attached drawings.

### BRIEF DESCRIPTION OF THE DRAWINGS

The disclosed low power reference scheme is described more or less diagrammatically in the accompanying drawings wherein:

FIG. 1 is a schematic of an exemplary direct peripheral interconnect system, as applied to a peripheral network and associated control unit, that is constructed in accordance with this disclosure;

FIGS. 2A and 2B are schematics of two direct peripheral interconnect systems as applied to two different peripheral networks;

FIG. 3 is a schematic of another direct peripheral interconnect system;

FIG. 4 is a schematic of a direct peripheral interconnect device; and

FIG. 5 is a flow diagram of a method for providing a direct peripheral interconnect.

It should be understood that the drawings are not necessarily to scale and that the embodiments are sometimes illustrated by graphic symbols, phantom lines, diagrammatic representations and fragmentary views. In certain instances, details which are not necessary for an understanding of this disclosure or which render other details difficult to perceive may have been omitted. It should be understood, of course, that this disclosure is not limited to the particular embodiments and methods illustrated herein.

### DETAILED DESCRIPTION OF THE DISCLOSURE

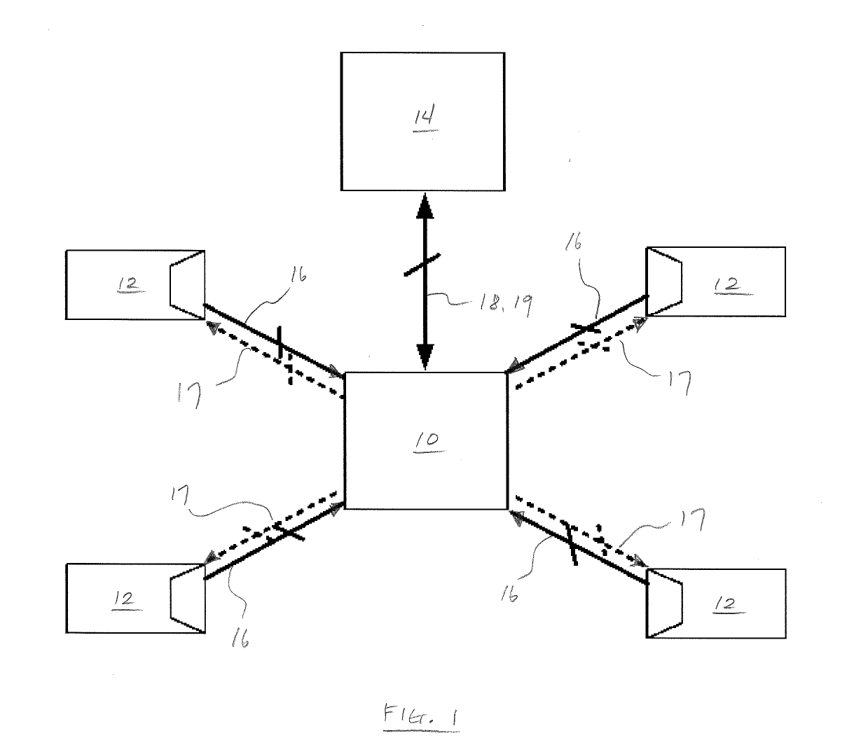

FIG. 1 illustrates an exemplary direct peripheral interconnect (DPI) system 10 constructed in accordance with this disclosure. As shown, the DPI system 10 may be configured to directly interconnect one or more peripherals 12 associated with a main control unit 14. Moreover, the control unit 14 may be configured to consolidate its communications with the DPI system 10 rather than with each peripheral 12 directly so as to conserve its resources and minimize overall power consumption and latency. More specifically, the DPI system 10 may provide the peripherals 12 with the means necessary for performing any one of a plurality of functions, and further, update the control unit 14 accordingly.

Still referring to the embodiment of FIG. 1, the peripherals 12 may comprise a timer, analog to digital converter (ADC), digital to analog converter (DAC), counter, comparator, or any other peripheral as is well known in the art of computer architecture. Each of the peripherals 12 may be configured to send and/or receive signals including flags, bits, values, triggers, and the like, which may be required to initiate an event in a particular module, for example, the peripheral 12, control unit 14, or the like. More specifically, each of the signals 16, 17 of the peripherals 12 may be configured to output producer signals 16 and receive consumer signals 17. In turn, the DPI system 10 may be configured to receive each of the producer signals 16 output by the peripherals 12, and further, output consumer signals 17 to the associated peripherals 12. The DPI system 10 may also be configured to send and/or receive control signals 18 and/or status signals 19 with the control unit 14. The control and status signals 18, 19 may include flags, bits, values, triggers, or any other suitable time-dependent or time-independent signals commonly used in the art. The main control unit 14 may include a microcontroller, processor, microprocessor, central processing unit (CPU), or the like.

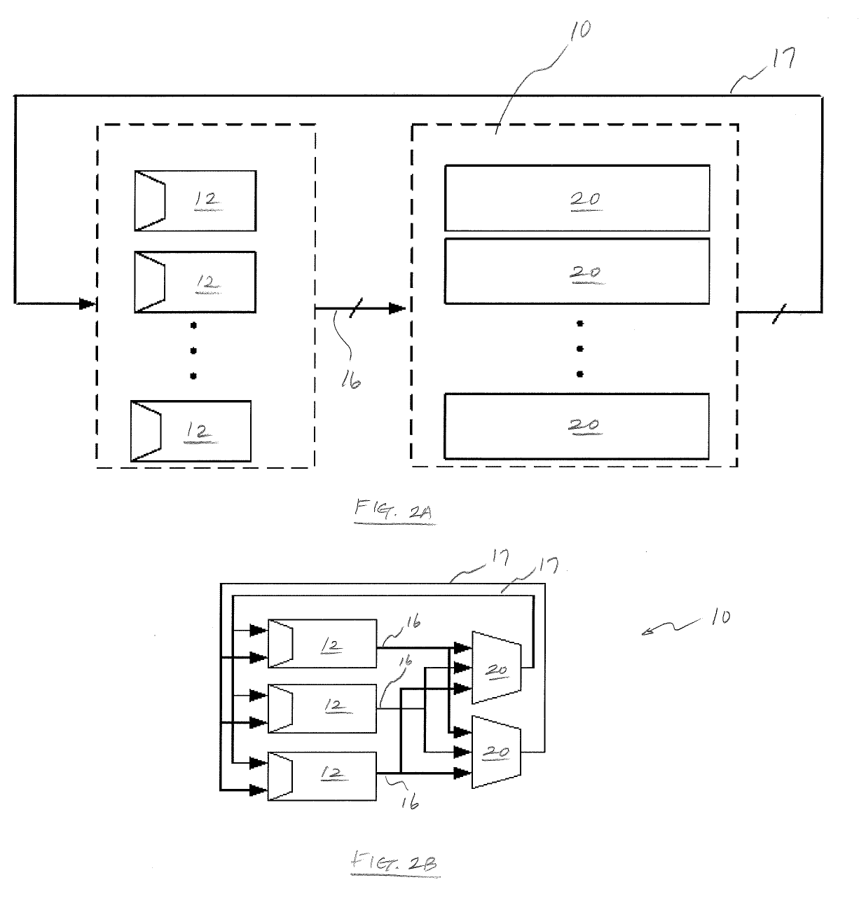

Turning to FIG. 2A, exemplary interconnections between a DPI system 10 and a network of peripherals 12 is provided. As illustrated, the DPI system 10 may include one or more DPI channels or devices 20 which interconnect one or more peripherals 12 by way of a bus, or the like. As in the previous embodiment, the bus may be employed to transmit and/or receive, for example, producer signals 16 and consumer signals 17. As further disclosed in FIG. 2B, each DPI device 20 may be configured to output a consumer signal 17 to be received at an input of each of the peripherals 12. Furthermore, each DPI device 20 may be configured to receive each respective producer signal 16 provided by the peripherals 12. In such a way, the system 10 of DPI devices 20 may provide a direct interconnect between the respective inputs and outputs of each of the peripherals 12.

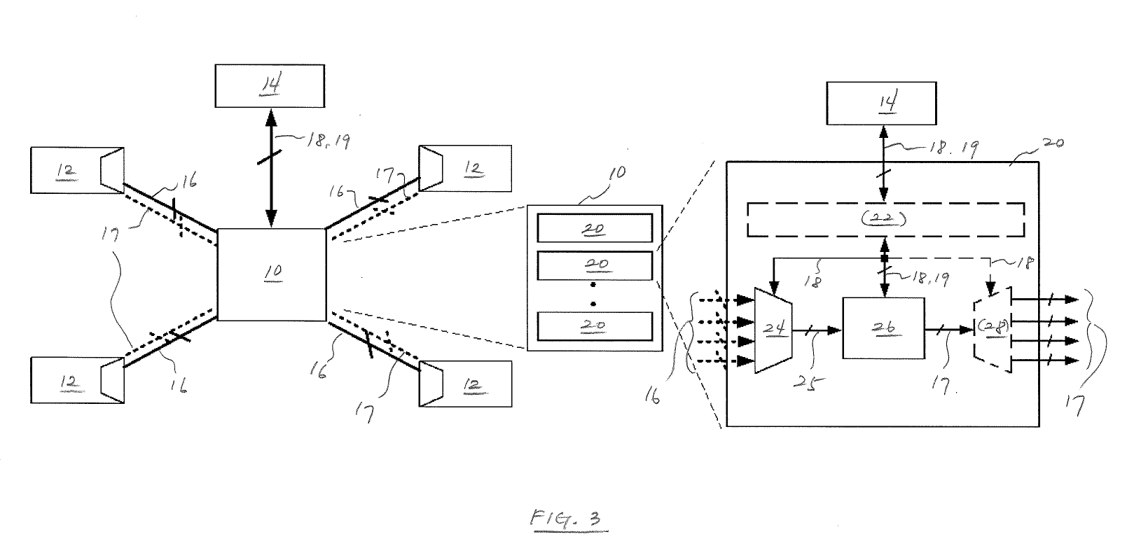

Referring now to FIG. 3, another exemplary DPI device 20 is provided in more detail. As disclosed in previous embodiments, the DPI device 20 may be in direct communication with the control unit 14 via the control and status signals 18, 19. Optionally, the DPI device 20 may provide an interface 22, or the like, to facilitate the exchange of information between the control unit 14 and each of the DPI channels or devices 20. The DPI device 20 may essentially include a selector 24 and an operator 26. In particular, the selector 24 may be a multiplexer, or the like, configured to receive a number of producer signals 16 that are provided by one or more peripherals 12, as well as one or more control signals 18 provided by the control unit 14. Based on the information received from the control unit 14 via the control signals 18, and/or information which may have been previously configured by other related functions or operations, the selector 24 may allow one or more of the received producer signals 16 to be simultaneously switched through to its output, for example, as one or more operable signals 25. The operable signals 25 may then be routed to the operator 26 for further processing.

The operator 26 of FIG. 3 may be provided with one or more functions to be performed on a particular operable signal 25. More specifically, one or more commonly used functions may be stored within a memory of the operator 26. Based on the information received from the control unit 14 via the control signals 18, the operator 26 may select or recall one or more of the stored functions to be performed on the operable signal 25. The operator 26 may further perform the selected functions on the operable signal 25, and subsequently, output the resulting signal as a consumer signal 17 to be routed to the relevant peripherals 12. Optionally, the DPI device 20 may further include a second selector 28, such as a demultiplexer, or the like, to assist the operator 26 in routing the consumer signals 17 to the respective peripherals 12. Particularly, the selector 28 may be configured to receive the consumer signals 17 from the output of the operator 26, as well as one or more control signals 18 provided by the control unit 14. Based on the control signals 18, the selector 28 may select the appropriate destination peripherals 12, and further, route one or more of the consumer signals 17 to only those peripherals 12 designated as such. As a further option, the DPI device 20 may be configured to first assess an input received to determine if an operation must be performed and is even needed. Furthermore, the operator 26 may be configured to provide a feedback or status signal 19 to the control unit 14. The status signal 19 may include update information pertaining to the selected producer signal 16, the selected function, the resulting consumer signal 17, the progress of the executed function, the selected destination peripherals 12, and the like.

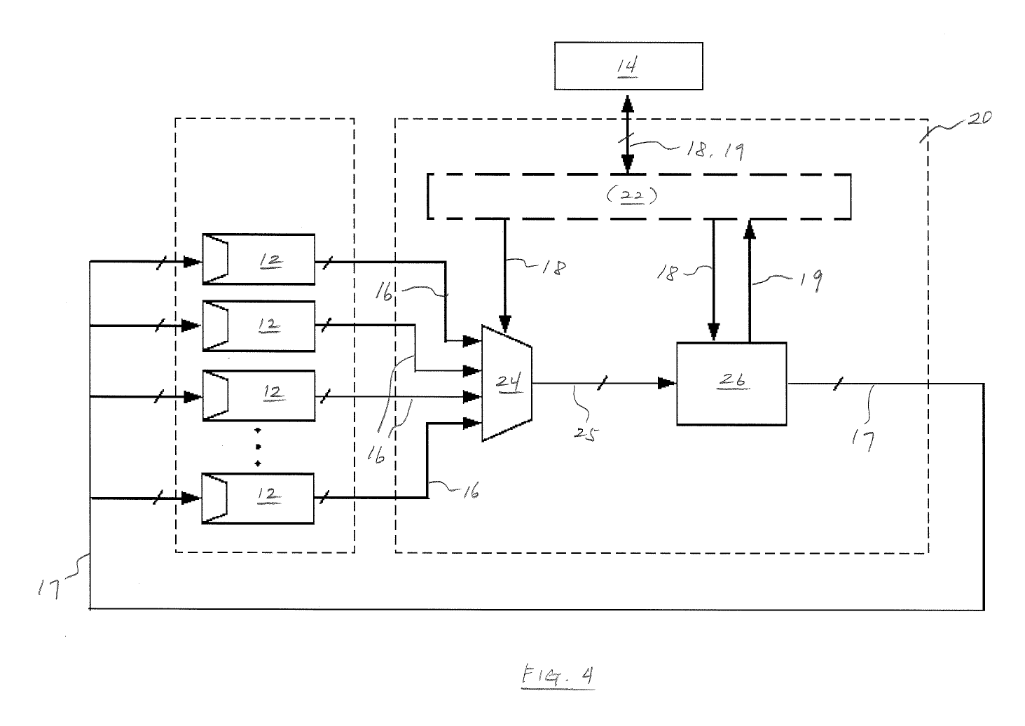

Turning now to FIG. 4, another exemplary DPI device 20 is illustrated as being interconnected between a number of peripherals 12 and communicating directly with a control unit 14. As in previous embodiments, the DPI device 20 of FIG. 4 may include one or more selectors 24 configured to receive producer signals 16 generated from one or more peripherals 12. According to the one or more control signals 18 received from the control unit 14, the selector 24 may route only one, or alternatively more than one, of the producer signals 16 to its output as an operable signal 25. The operator 26 may receive the one or more operable signals 25 and select the appropriate function to perform based on the control signal 18 received. Upon performing a particular function, the operator 26 may output a consumer signal 17 to the appropriate peripherals 12 for any additional processing needed. During any time of the processes disclosed, the operator 26 may further transmit or store a status bit, flag or signal 19 to the control unit 14. The status signal 19 may provide the control unit 14 with feedback pertaining to the selected producer signal 16, the selected function, the resulting consumer signal 17, the progress of the executed function, the selected destination peripherals 12, and the like. Furthermore, such communications between the DPI device 20 and the control unit 14 may be processed and/or controlled via, for example, an optional interface 22 communicatively disposed between the control unit 14 and subcomponents 24, 26 of the DPI device 20. The operator 26 of FIG. 4 may include a plurality of functions from which the operator 26 may autonomously select an appropriate function to perform on an operable signal 25. For instance, as indicated by the inward direction of the control signal 18 of FIG. 4, the connections between the control unit 14 and the operator 26 may be used to select a function, upload a function, or apply any other function configurations.

More specifically, the operator 26 may be provided with a memory within which a number of different recallable functions may be stored at different addresses of the memory. Accordingly, the control signals 18 provided to the operator 26 may include memory address information which corresponds to any particular operable signal 25 received by the operator 26. Based on the address information received from the control unit 14, the operator 26 may select the corresponding address, recall the appropriate function to perform on the operable signal 25 and execute the function autonomously, or without further intervention from the control unit 14. Any updated information regarding the operations of operator 26 and/or the resulting consumer signals 17 may be transmitted to the control unit 14 via status signals 19 as appropriate. Moreover, as indicated by the outward direction of the status signal 19 of FIG. 4, the connections between the control unit 14 and the operator 26 may be used to inform the control unit 14 of feedback pertaining to any one of a particular operable signal 25, the selected function, status of a particular operation, or the like. Furthermore, each of the functions provided to the operator 26 may be generalized such that all operable signals 25, including pulsed signals, level signals, and the like, may be received and operated on by the operator 26. The functions may also be configurable via an interface of the DPI system 10 such that additional functions may be added, unnecessary functions may be removed, existing functions may be modified, and the like. By restricting the dependency of the peripherals 12 on a central control unit 14 to a bare minimum, the DPI device 20 of FIG. 4 may significantly reduce power consumption and minimize the effects of latency.

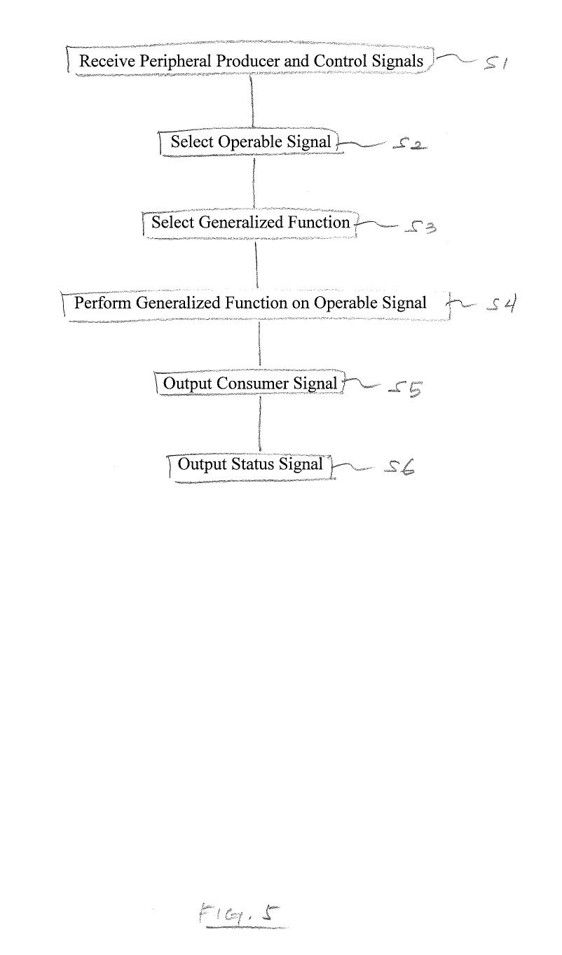

Referring now to the flow diagram of FIG. 5, an exemplary method for providing a direct interconnect between peripherals is provided. For instance, in a step S1, the producer signals 16 output by the peripherals 12 as well as control signals 18 output by a control unit 14 may be received by a selector 24, or the like. Based on information contained within the control signals 18, the selector 24 may select one or more of the received producer signals 16 to be transmitted therethrough as an operable signal 25, in a step S2. In a step S3, a generalized function may be selected based on information contained with the control signals 18 provided by the control unit 14. The generalized function may be performed or executed on the operable signal 25, in a step S4. Once the appropriate functions are performed by an operator 26, or the like, in step S4, the resulting signal, or consumer signal 17, may be output to the appropriate peripherals 12, in a step S5. In an optional step S6, the operator 26 may further output a status signal 19 to the control unit 14 providing update information pertaining to the operable signal 25, selected function, progress of a particular operation, or the like. Each step S1-S6 of FIG. 5 may be configured to operate autonomously and with minimized intervention from a control unit 14. In such a way, an improved peripheral network may be configured to have predictable timing characteristics, low latency and low jitter operations in response to signals, such as producer signals 16, consumer signals 17, control signals 18 and/or status signals 19.

### INDUSTRIAL APPLICABILITY

In satisfaction of the above-identified needs, an improved network peripheral that can significantly reduce power consumption and minimize the effects of latency is disclosed. The peripheral network is formed using a system 10 of direct peripheral interconnect (DPI) devices 20 capable of performing tasks autonomously with substantially less intervention from a central control unit 14. Moreover, the DPI device 20 serves to receive producer signals 16 output by peripherals 12, and receive control signals 18 output by a main control unit 14. The DPI device 20 further selects at least one of the producer signals 16 as an operable signal 25 based on the control signals 18 received. One or more functions to be performed on the operable signal 25 are selected based on the control signals 18. Once the selected functions are performed, the resulting consumer signals 17 are output to at least one of the peripherals 12. A status signal 19 providing update information of the operation is also output to the main control unit 14. Such DPI systems 10 provide direct communications between peripherals 12 so as to signal and trigger peripheral tasks with minimal input from a central control unit 14, or the like. In such a way, peripheral operations having more predictable timing characteristics, lower latency and lower jitter are provided.

While only certain embodiments have been set forth, alternatives and modifications will be apparent from the above description to those skilled in the art. These and other alternatives are considered equivalents and within the spirit and scope of this disclosure and the appended claims.

What is claimed:

1. An interconnect apparatus for providing direct interconnections between one or more peripherals so as to minimize interactions with a main control unit, comprising:
at least one selector configured to receive producer signals output by the peripherals and control signals output by the main control unit, the selector being configured to select and output at least one of the producer signals as an operable signal based on the control signals; and
at least one operator having one or more functions stored therein, the operator being configured to receive the operable signal and the control signals, the operator being configured to perform at least one of the functions on the operable signal based on the control signals, the operator being configured to output a consumer signal corresponding to the operable signal, the operator further being configured to output a status signal to the main control unit.

2. The interconnect apparatus of claim 1 further comprising an interface communicatively disposed between the main control unit and each of the selector and operator.

3. The interconnect apparatus of claim 1, wherein the main control unit is a central processing unit.

4. The interconnect apparatus of claim 1, wherein the selector is a multiplexer.

5. The interconnect apparatus of claim 1, wherein the control signals include information pertaining to the producer signals to be selected as the operable signal.

6. The interconnect apparatus of claim 1, wherein the control signals include information pertaining to the function to be performed on the operable signal.

7. The interconnect apparatus of claim 1, wherein the status signal includes information pertaining to the at least one function performed.

8. The interconnect apparatus of claim 1, wherein the functions are generalized so as to be executable on pulsed or level operable signals.

9. The interconnect apparatus of claim 1, wherein, before performing any function, the operator is configured to determine if one of the functions must be performed, based on at least one of the operable and control signals received.

10. The interconnect apparatus of claim 1 further comprising a second selector configured to receive the control signals, select at least one of the peripherals as destination peripherals, and output the consumer signal to only the destination peripherals.

11. The interconnect apparatus of claim 1, wherein each of the selector and operator has predictable timing characteristics.

12. The interconnect apparatus of claim 1, wherein each of the selector and operator is autonomous.

13. The interconnect apparatus of claim 1, wherein each of the selector and operator includes substantially low latency and low jitter operations.

14. A method for providing an autonomous direct interconnect between one or more peripherals so as to minimize interactions with a main control unit, comprising the steps of:
receiving producer signals output by the peripherals at the interconnect;
receiving control signals output by the main control unit at the interconnect;
selecting at least one of the producer signals as an operable signal based on the control signals;
selecting one or more functions to perform on the operable signal based on the control signals;
performing at least one of the functions on the operable signal; and
outputting a consumer signal corresponding to the operable signal and the function performed to at least one of the peripherals.

15. The method of claim 14, wherein the functions are generalized so as to be executable on pulsed or level operable signals.

16. The method of claim 14, wherein the functions are configurable through an interface.

17. The method of claim 14, wherein each producer signal is synchronized with a clock of the associated peripheral.

18. The method of claim 14, wherein the step of selecting at least one of the functions is performed by at least one multiplexer.

19. The method of claim 14, wherein timing of each of step is predictable.

20. The method of claim 14 further comprising a step of outputting a status signal to the main control unit.

21. The method of claim 20, wherein the status signal includes information pertaining to the consumer signal and the function performed.
